(19) United States
(12) Patent Application Publication
(10) Pub. No.: US 2016/0137885 A1
(43) Pub. Date: May 19, 2016

(54) ARTICLE COMPRISING AN ADHESIVE LAYER COMPRISING FIRST AND SECOND PRESSURE-SENSITIVE ADHESIVE STRIPES

(71) Applicant: 3M INNOVATIVE PROPERTIES COMPANY, Saint Paul, MN (US)

(72) Inventors: Gary W. Maier, Roberts, MN (US); Carlos A. Barrios, Woodbury, MN (US); James L. Bries, Cottage Grove, MN (US); Tyler J. Rattray, Minneapolis, MN (US)

(21) Appl. No.: 14/901,324

(22) PCT Filed: Jun. 13, 2014
(86) PCT No.: PCT/US2014/042297

§ 371 Date: Dec. 28, 2015

Related U.S. Application Data
(60) Provisional application No. 61/838,510, filed on Jun. 24, 2013.

(51) Int. Cl. C09J 7/02

(52) U.S. Cl. CPC C09J 7/0246; C09J 183/08

(57) ABSTRACT

An article including a first substrate with an adhesive layer disposed thereon, the adhesive layer including a plurality of stripes of a first pressure-sensitive adhesive and of a second pressure-sensitive adhesive, arranged in a generally alternating pattern.

### BACKGROUND

Pressure-sensitive adhesives (PSAs) are widely used for various bonding applications. In particular, stretch-releasable pressure-sensitive adhesive tapes are often used to bond an item to e.g. a surface of a building component. The item can be released from the surface by stretching the adhesive tape, leaving little or no adhesive residue on the surface.

### SUMMARY

In broad summary, herein is disclosed an article including a first substrate with an adhesive layer disposed thereon, the adhesive layer including a plurality of stripes of a first pressure-sensitive adhesive and of a second pressure-sensitive adhesive, arranged in a generally alternating pattern. In some aspects, the average thickness of the stripes of the first adhesive may be less than the average thickness of the stripes of the second adhesive. In some aspects, the first adhesive may provide a volume fraction of the primary adhesive layer of from greater than about 10%, to about 50%. These and other aspects of the invention will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a schematic cross sectional slice view of a portion of an exemplary article as disclosed herein.

FIG. 2 is a schematic cross sectional slice view of a portion of another exemplary article as disclosed herein.

FIG. 3 is a top perspective view of another exemplary article as disclosed herein.

FIG. 4 is a schematic cross sectional slice view of a portion of another exemplary article as disclosed herein.

FIG. 5 is a schematic cross sectional slice view of a portion of another exemplary article as disclosed herein.

FIG. 6 is a schematic cross sectional slice view of a portion of another exemplary article as disclosed herein.

FIG. 7 is a schematic cross sectional slice view of a portion of another exemplary article as disclosed herein.

FIG. 8 is a schematic cross sectional slice view of a portion of another exemplary article as disclosed herein.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “top”, bottom”, “upper”, lower”, “under”, “over”, “front”, “back”, “up” and “down”, and “first” and “second” may be used in this disclosure, it should be understood that those terms are used in their relative sense only unless otherwise noted. The terms inward, outward, and lateral have particular meanings as defined later herein. The term “adhesive” as used herein means a pressure-sensitive adhesive. As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

### DETAILED DESCRIPTION

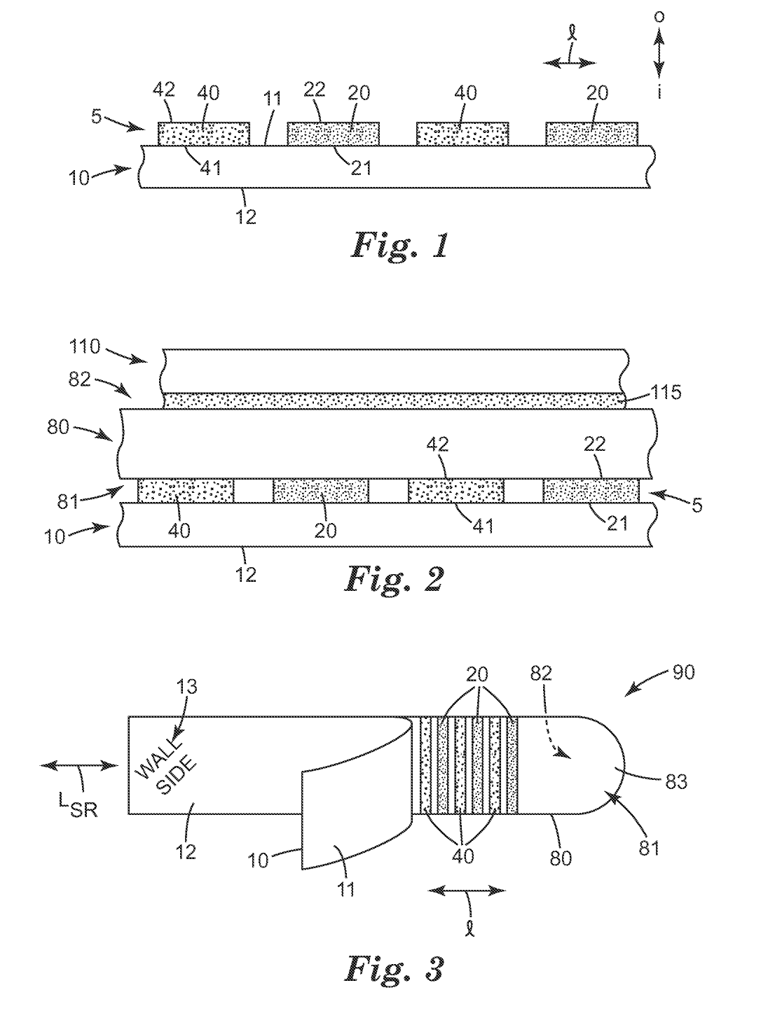

Shown in FIG. 1 is a schematic cross sectional slice view of a portion of an exemplary article (viewed along the long axis of stripes 20 and 40) as disclosed herein. The article comprises a substrate 10 with a first major surface 11 and a second major surface 12 that faces oppositely from first major surface 11. A primary adhesive layer 5 is disposed on first major surface 11 of substrate 10. Adhesive layer 5 comprises a plurality of stripes of a first pressure-sensitive adhesive 20 and of a second pressure-sensitive adhesive 40, arranged in a generally alternating pattern across a lateral extent “l” of substrate 10, as shown in exemplary manner in FIG. 1. (By a lateral direction, and the resulting lateral extent, is meant a direction that is substantially perpendicular to the long axes of the stripes). First pressure-sensitive adhesive 20 and second pressure-sensitive adhesive 40 may be any two (or more) pressure-sensitive adhesives that differ in properties (e.g., by virtue of differing in composition), as discussed in detail later herein. Substrate 10 may be any desired substrate, e.g. a release liner, as discussed in detail herein.

As stated above, stripes of pressure-sensitive adhesives 20 and 40 are arranged in a generally alternating pattern. An exemplary version of this is as shown e.g. in FIGS. 1-3, in which the following pattern is found: [40/20/40/20 . . . ]. However, the concept of generally alternating also includes patterns in which any selected stripe (whether of adhesive 20 or 40) can be provided in the form of two or more sub-stripes. For example, one of e.g. stripes 20 or 40 could be provided as two sub-stripes with a gap in between, instead of as a single stripe as shown in FIG. 1. Thus, for example, a generally alternating pattern includes such patterns as [20/(40/40)/20/(40/40) . . . ]; that is, a pattern in which two 40 sub-stripes are followed by a single 20 stripe); and, [(20/20)/(40/40/40) . . . ]; that is, a pattern in which two 20 sub-stripes are followed by three 40 sub-stripes), and so on. In many embodiments, stripes of pressure-sensitive adhesives 20 and 40 will be elongated (e.g., as shown in FIG. 3) so as to comprise long axes, although such long axes do not necessarily have to be strictly linear.

In at least some embodiments, the disclosed article may comprise a secondary substrate (e.g., a tape backing) 80, as shown in exemplary embodiment in FIGS. 2 and 3. In such embodiments, at least selected stripes of the plurality of stripes may each comprise a first major surface that is in contact with a release surface 11 of first substrate 10, and at least selected stripes of the plurality of stripes may each comprise a second, oppositely-facing major surface that is pressure-sensitive-adhesively bonded to first major side/surface 81 of secondary substrate 80. In the illustrated embodiment of FIG. 2, stripes 20 and 40 comprise first major surfaces (21 and 41, respectively) that are in contact with surface 11 of substrate 10; and, stripes 20 and 40 comprise second major surfaces (22 and 42, respectively) that are bonded to first major side/surface 81 of secondary substrate 80. However, this may not always be the case, as will be appreciated from discussions later herein.

Secondary substrate 80 can comprise e.g. any type of backing that may be suitable for forming any desired type of article, e.g. tape. In particular embodiments, backing 80 may comprise a highly-extensible backing as discussed in detail later herein, so that the provided article can function as a stretch-releasable adhesive tape. In some embodiments, a secondary pressure-sensitive adhesive layer 115 may be provided on the secondary (opposite) side of tape backing 80 from primary pressure-sensitive adhesive layer 5. Such an arrangement can provide a so-called double-faced adhesive tape. If desired, secondary adhesive layer 115 may have the same (e.g., striped) arrangement and/or composition as primary adhesive layer 5. However, in many embodiments (since adhesive layer 115 may often be bonded e.g. to an item to be mounted on a wall, rather than to a mounting surface of the wall itself), secondary adhesive layer 115 can comprise any suitable adhesive. If desired, a secondary release liner 110 may be provided on secondary side 82 of tape backing 80, as shown in exemplary embodiment in FIG. 2.

In some embodiments, tape backing 80, and primary and secondary adhesive layers 5 and 115, can collectively provide a double-faced stretch-releasable adhesive tape. Such articles are often used to removably attach items to e.g. building components such as walls and the like. FIG. 3 thus shows an exemplary stretch-releasable article 90, comprising a highly extensible backing 80 with stripes 20 and 40 of first and second adhesives disposed on a portion thereof in a generally alternating pattern. Article 90 further comprises a tab portion 83 (e.g. a portion of backing 80 that does not have any adhesive disposed thereon), which tab portion 83 can be grasped and pulled to activate the stretch-release property of the article. In many embodiments, such a stretch-releasable article may comprise an elongate length with a long axis L_{SR}, which long axis serves as the axis along which the article can be pulled to activate the stretch-release property. As can be seen in FIG. 3, in some embodiments the individual stripes 20 and 40 of the first and second adhesives can each have a long axis that is oriented generally, substantially, or even strictly perpendicular to the long axis L_{SR} of the elongate length of stretch-releasable article 90 (with the latter case being shown in FIG. 3). It will be appreciated that such stretch-releasable articles are customarily mounted to a wall so that the long axis of the article is aligned vertically (with respect to the earth's gravity) so as to most advantageously bear the weight of an item to be supported by the article. It is thus noted that the functioning described herein may be obtained even when the individual stripes of adhesive are oriented perpendicular to the long axis of the article and thus to the gravitational load imparted by the supported object. In various embodiments, however, the long axes of stripes 20 and 40 can be oriented at any convenient angle (e.g., parallel to, or from 30, 45, 60, or 90 degrees away from parallel to) with respect to the long axis L_{SR} of stretch-releasable article 90. And, as mentioned, the individual stripes do not necessarily have to extend purely in a straight line; that is, they can be at least slightly wavy, bowed, sinusoidal, etc.

As will be appreciated based on later disclosures herein, primary adhesive layer 5 may be advantageously bonded to e.g. mounting surfaces of building components, particularly to certain painted surfaces of such components. Thus, in some embodiments a visible surface 12 of first substrate 10 may comprise an indicia 13 indicating that first substrate 10 is a release liner that is disposed on the major side of double-faced stretch-releasable adhesive tape article 90 that is configured to be bonded to a mounting surface of a building component, (upon removal of release liner 10). Such an arrangement is shown in exemplary embodiment in FIG. 3.

Individual stripes of adhesives 20 and 40 of adhesive layer 5 may have any desired (lateral) width. In various embodiments, an individual stripe may comprise an average width that is at least about 0.1, 0.2, or 0.4 mm (noting that the width of a stripe may occasionally vary somewhat along the long axis of the stripe). In further embodiments, an individual stripe may comprise an average lateral width that is at most about 2, 1, or about 0.6 mm. Stripes of a particular type (e.g., of adhesive 20 or 40) do not all have to be of the same width; moreover, stripes 20 do not have to be the same width as stripes 40. As discussed herein, the width of some stripes 20 (and 40) may be different on the side of the stripe that faces substrate 10, from the width on the opposite side. For such stripes, the average widths refer to the average of the widths on the two sides of the stripe.

Stripes 20 and 40 may be provided at any desired pitch (i.e., the center-to-center distance between adjacent stripes). It may be advantageous that the pitch be relatively small e.g. so that a relatively smooth and continuous removal process (e.g., when peeling a conventional tape, or when stretching a stretch-releasable tape) may be obtained. Thus, in various embodiments, the center-to-center pitch between adjacent stripes may be at most about 4, 2.5, 2, 1.5, or 1 mm. In further embodiments, such a center-to-center pitch may be at least about 0.5, 1, 1.5, or 2 mm. The pitch does not have to be constant, but can be if desired. Individual stripes 20 and/or 40 may often be continuous along their long axis, but can be discontinuous (interrupted) if desired. However, in any case, such stripes will be distinguished (i.e., by way of each stripe being comprised of segments that each comprise a long axis that is coincident with the long axis of the stripe) from e.g. adhesives that are deposited on a surface as an array of dots by way of e.g. gravure coating, screen printing, and the like.

Thickness of Stripes

Individual stripes 20 and 40 may have any suitable average thickness (in the inward-outward direction relative to first substrate 10, as designated in FIG. 1). In various embodiments, stripes 20 and/or 40 may comprise an average thickness of at least about 10, 20, 40, or 60 microns. In further embodiments, stripes 20 and/or 40 may comprise an average thickness of at most 140, 100, 80, or 70 microns. In some embodiments, all stripes of a particular type may be similar in thickness and/or stripes 40 may have approximately the same average thickness as that of stripes 20 (as in the general designs illustrated in FIGS. 1, 2, 4 and 5). However, it may not be required that all stripes have identical thickness or even similar thickness, as discussed in detail below. The thickness of some stripes 20 (and/or 40) may vary across the lateral width of the stripe as discussed later herein. For such stripes, the average thickness can be measured at or near the lateral center of the stripe (e.g., thickness T_{lc} as shown in FIG. 6). In some embodiments, liner-facing major surfaces 21 of stripes 20 may be coplanar with liner-facing major surfaces 41 of stripes 40.

Volume Fractions/Thickness Mismatch

The arrangements disclosed herein can provide benefits by allowing the actual bonding surface area provided by a first adhesive to be greater than that which would be expected based on the volume fraction at which the first adhesive is present in adhesive layer 5. By the volume fraction provided by an adhesive is meant the fraction (percentage) of the total volume of adhesive layer 5 (including that occupied by any gaps, if present) that is collectively occupied by the stripes of that adhesive. In at least some embodiments, the volume fraction at which first adhesive 20 is present may be manipulated by arranging for the thickness of at least some of the stripes of first adhesive 20 to be different from the thickness of stripes of second adhesive 40. Specifically, the thickness of at least some of the stripes of a first adhesive 20 relative to that of the stripes of a second adhesive 40, may be advantageously minimized (as seen e.g. in the exemplary design of FIG. 8) so as to use a lower volume fraction of first adhesive 20 while preserving acceptable properties of adhesive layer 5. By way of illustration, it is evident from Tables 1-3 of the Working Examples that the relative (average) thickness of first adhesive stripes 20 may be lower than the (average) thickness of second adhesive stripes 40 by a factor of e.g. 1.2., 1.5, 2.0, 2.5, 3.0, or even 3.4. Such embodiments can allow the use of a very low volume fraction of first adhesive 20, while still achieving and maintaining an acceptable bond.

By way of specific illustration, Working Example 2-1 (Table 2) comprised an overall area fraction of first adhesive 20 of approximately 33% (with the 67% balance being supplied by second adhesive 40). However, because the stripes of first adhesive 20 were much thinner than those of second adhesive 40 (approximately 0.8 mils versus 2.7 mils), the volume fraction of first adhesive 20 was only approximately 13% (with the 87% balance being made up by second adhesive 40). It is thus evident from comparison of Working Example 2-1 to Comparative Example PSA-S-2 that in at least some embodiments, an adhesive layer 5 can be used that comprises a volume fraction of a first adhesive 20 of as low as about e.g. 13%, while still preserving at least some of the properties that are exhibited by the use of an adhesive layer 5 that is comprised of 100 volume % of the first adhesive 20.

Thus in various embodiments, an average thickness of the stripes of the second pressure-sensitive adhesive may be greater than an average thickness of the stripes of the first pressure-sensitive adhesive by a factor of at least 1.2, 1.6, 2.0, 2.5, 3.0, or 3.5 or more. (In such embodiments, liner-facing major surfaces 21 of stripes 20 may be coplanar with liner-facing major surfaces 41 of stripes 40.) It is noted that the presence, in adhesive layer 5, of a large mismatch between the thickness of the stripes of first and second adhesives (e.g., up to a factor of 3.4) might be expected by the skilled artisan to disadvantageously affect the ability of adhesive layer 5 to achieve and maintain a bond. While not wishing to be limited by theory or mechanism, it is believed that any of several factors may enhance the ability of adhesive layer 5 to achieve and maintain an adequate bond even in the case of such a thickness mismatch. One factor may lie in the aspect ratio of the stripe width to the stripe thickness. Setting the aspect ratio in the proper range may allow that a majority of even a “recessed” surface of a thinner stripe can be contacted with the surface to which adhesive layer 5 is desired to be bonded. Thus, in various embodiments, the width/thickness aspect ratio of any of the adhesive stripes disclosed herein may be at least about 5, 10, 20, or 40 to 1. In further embodiments, such an aspect ratio may be at most about 200, 150, 100, 80, or 40 to 1.

Another factor that may arise in some embodiments may lie in the bonding of adhesive layer 5 to a secondary substrate 80 that is a relatively thick and conformable backing for example comprising a polymeric foam (to form e.g. a stretch-releasable article). As shown in exemplary illustration in FIG. 8, such a backing 80 might exhibit sufficient ability to conform to the contours of adhesives stripes 20 and 40 of mismatched thicknesses, that surface 81 of backing 80 is able to contact even the recessed surfaces 22 of thinner stripes 20 so as to satisfactorily achieve and maintain a bond. Thus in various embodiments, the thickness of a conformal backing 80 may be at least about four, eight, twelve, or sixteen times a thickness of primary adhesive layer 5 (noting that in the case in which mismatched thicknesses of stripes 20 and 40 are present, the thickness of the thicker stripes (i.e., stripes 40) is to be used as the thickness of primary adhesive layer 5 for the purpose of such calculations.

Still another factor may lie in the deposition (e.g., by coating as discussed later herein) of the adhesive stripes onto the surface of a substrate 10 that is a release liner. This has the advantageous result that even if stripes 20 are thinner than stripes 40, the bonding surfaces 21 of thinner stripes 20 that are to be bonded to a mounting surface (upon separation of release liner 10 from adhesive layer 5) may remain at least generally flush (even with) bonding surfaces 41 of thicker stripes 40 that are likewise to be bonded to the mounting surface. That is, any effect of the mismatched stripe thicknesses may be mostly evident on the opposite side of adhesive layer 5 (where they can be compensated for e.g. by the use of a relatively thick and conformable backing 80 if need be), with little effect of the thickness mismatch being evident at the surface of adhesive layer 5 that is to be bonded e.g. to a mounting surface. Thus, certain of the features disclosed herein, alone or in combination, may be particularly advantageous in some circumstances.

Adhesive-Free Gaps

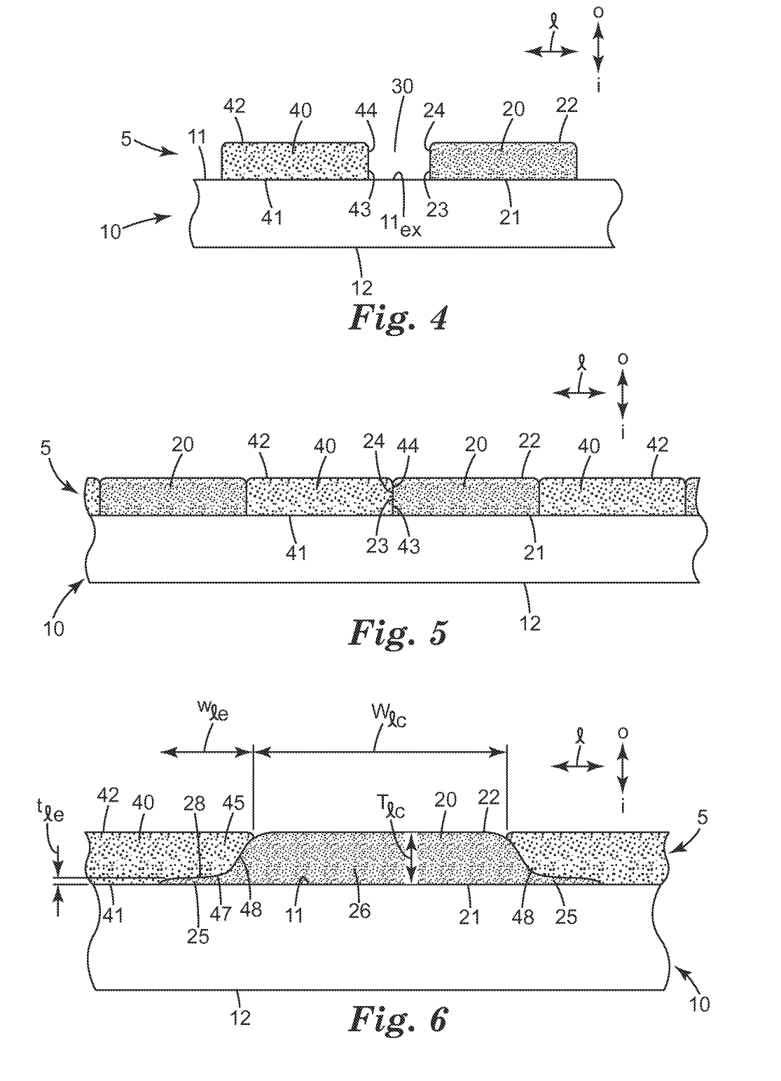

In at least some embodiments, the above-disclosed manipulation of the volume fraction of first adhesive 20 may be achieved at least in part by the use of adhesive-free gaps in between at least some of the stripes (or sub-stripes) of adhesive layer 5. Such arrangements are illustrated in exemplary manner in e.g. FIGS. 1-4. Thus, in such embodiments, at least some of stripes 20 and 40 may be spaced across a lateral extent of substrate 10 so that a gap 30 is present between two adjacent stripes 20 and 40, in which gap 30 an exposed surface 11ₑₓ of first surface 11 of first substrate 10 is present as shown in FIG. 4. It will thus be appreciated that primary adhesive layer 5 is not required to comprise a laterally continuous (uninterrupted) layer of adhesive. That is, adhesive layer 5 can be provided collectively by stripes 20 and 40, regardless of any gaps that might be interspersed between the various stripes. In arrangements of the general type shown in FIG. 4, at least some first adhesive stripes 20 may each comprise a lateral edge 23 comprising a lateral edge minor surface 24. Similarly, at least some second adhesive stripes 40 may each comprise a lateral edge 43 comprising a lateral edge minor surface 44. In such “spaced” arrangements, edges 23 and 43 (specifically, surfaces 24 and 44 thereof) of adjacent stripes 20 and 40 are not in contact with each other.

By way of specific illustration, for Working Example 1-1 (Table 1), the volume fraction of a first (silicone-based) adhesive 20 was approximately 16%, the volume fraction of a second adhesive 40 was approximately 39%, and the volume fraction of the gaps between the various stripes was approximately 45% (see the Test Procedures for a discussion of how these calculations are performed). Whether achieved primarily by the use of mismatched thicknesses, by gaps in between at least some adhesive stripes, or by a combination of both approaches, in various embodiments, a first pressure-sensitive adhesive 20 may be provided at a volume fraction of at least about 10, 12, 13, 15, 20, 25, 30, 35, or 40%. (The balance of adhesive layer 5 may be provided by second adhesive 40, alone or in combination with adhesive-free gaps, as mentioned). In further embodiments, first adhesive 20 may be provided at a volume fraction of at most about 55, 50, 45, 40, 35, 30, 25, or 20%. If any adhesive-free gaps are present, they may be conveniently characterized by way of a gap area fraction (discussed in further detail below). Accordingly, any of the herein-recited volume fractions of first adhesive 20 may be used e.g. in combination with a gap area fraction of from about 0, 10, 20, or 25% to about 60, 50, 40, or 35%.

Area Fractions

To aid in characterizing designs e.g. of the general type in which gaps are present between at least some stripes, for each of first and second adhesives 20 and 40 an overall area fraction can be defined that is the fraction (percentage) of the total area of adhesive layer 5 that is collectively occupied by the stripes of that adhesive. A gap area fraction of adhesive layer 5 that is collectively provided by any gaps may be similarly defined. For details of the measurement and calculation of such area fractions e.g. by optical methods, see the Test Procedures section of the Working Examples. Here and elsewhere herein, an area fraction will be with respect to the surface of adhesive layer 5 that is opposite from first substrate 10 unless specifically stated otherwise (noting that in many cases, e.g. in the absence of the herein-described surface-enrichment effects, the first-substrate-side area fraction of an adhesive will be essentially equal to the opposite-side area fraction of that adhesive).

By way of specific illustration, Working Example 1-1 (Table 1) comprised an overall area fraction of a first adhesive of approximately 23%, an overall area fraction of a second adhesive of approximately 33%, and a gap area fraction of approximately 44% (with the three parameters adding to approximately 100% of the total area of adhesive layer 5). Thus in various embodiments, a first adhesive 20 may provide an overall area fraction of adhesive layer 5 of at least about 20, 25, 30, 35, or 40%. In further embodiments, a first adhesive 20 may provide an overall area fraction of adhesive layer 5 of at most about 70, 60, 50, or 40%.

The Working Examples (e.g., Table 1) demonstrate that in some cases a gap area fraction of up to e.g. 46% or more may be present. That is, in some cases as much as e.g. 46% or more of the total area of adhesive layer 5 may be empty of adhesive (that is, will be occupied by exposed surface 11ₑₓ of substrate 10), while still providing excellent resistance to e.g. peel forces and shear forces (when adhesive layer 5 is bonded to an item after release liner 10 is separated from layer 5). In fact, excellent performance can be maintained even in an arrangement (discussed above with reference to FIG. 3) in which the individual adhesive stripes of an adhesive layer are oriented with their long axes perpendicular to the shear force (gravitational load) placed on the adhesive layer. This is unexpected in that the presence of such large and/or numerous gaps along the shear path in between the adhesive stripes might be expected to significantly reduce the collective ability of the stripes to withstand high shear forces. Thus, in various embodiments, adhesive layer 5 may comprise a gap area fraction of at least about 10, 20, 30, or 40%. In further embodiments, adhesive layer 5 may comprise a gap area fraction of at most about 60, 50, 45, 40, 35, or 30%. (As discussed below, in some embodiments the gap area fraction may be lower than 10%; in particular embodiments, no gaps may be present at all.)

For each adhesive, an adhesive-only area fraction can also be defined, which parameter denotes the fraction of the total area occupied by the adhesive stripes, that is provided by the stripes of that particular adhesive. The adhesive-only area fractions are thus indicative of the relative areas occupied by the first and second adhesives on an adhesive-only basis, irrespective of any area that is occupied by gaps in which no adhesive is present. For example, the adhesive-only area fraction of the first adhesive of Working Example 1-2 was approximately 38%; the adhesive-only area fraction of the second adhesive of Working Example 1-2 was approximately 62%.

In some circumstances the herein-disclosed relatively low volume fractions of a first adhesive 20 may be achieved without the use of mismatched stripe thicknesses; e.g. in some embodiments they may be achieved exclusively by the use of adhesive-free gaps. Thus in some embodiments, the average thickness of first adhesive stripes 20 may be within plus or minus 40, 20, 10, or 5% of the average thickness of second adhesive stripes 40. In still other circumstances, it may be desired that the thickness of first adhesive stripes 20 may be greater than that of second adhesive stripes 40.

Stripes in Lateral Contact with Each Other

In some embodiments, at least selected pairs of adjacent stripes of first adhesive 20 and second adhesive 40 may be configured so that a minor surface 24 of a lateral edge 23 of first pressure-sensitive adhesive stripe 20, is in generally lateral contact with a minor surface 44 of a lateral edge 43 of second pressure-sensitive adhesive stripe 40. Such an arrangement is shown in exemplary manner in FIG. 5. It will be understood that by generally lateral contact is meant that the majority of the interface between surfaces 24 and 44 is aligned generally perpendicular to (that is, within plus or minus 20 degrees of perpendicular to) the major plane of substrate 10. Such an arrangement may be distinguished from e.g. arrangements such as those of FIG. 6, which are discussed later herein. Thus, in some embodiments the herein-disclosed reduction of the volume fraction at which a first adhesive is present may be achieved without the use of adhesive-free gaps; e.g. in some embodiments they may be achieved exclusively by the use of stripes 20 that are thinner than stripes 40.

Stripes with Surface Enrichment

In some embodiments, at least selected pairs of adjacent stripes of first adhesive 20 and second adhesive 40 may be configured (as shown in exemplary embodiment in FIG. 6) so that a lateral edge portion 25 (with a width wₗₑ) of first pressure-sensitive adhesive stripe 20 inwardly underlies a lateral edge portion 45 of second pressure-sensitive adhesive stripe 40. (Many stripes of this general type will comprise two such lateral edge portions 25 that flank a laterally central portion 26 that has a width W_{lc}, as shown e.g. in FIG. 6). As can be appreciated from the exemplary illustration of FIG. 6, by inwardly underlies means that a straight line that is passed in an outward→inward direction through portion 45 of second adhesive stripe 40 will pass through portion 25 of first adhesive stripe 20 before reaching substrate 10. Thus in such arrangements, rather than interface 48 between adjacent edge surfaces of stripes 20 and 40 being substantially perpendicular to the major plane of substrate 80 (as in the design of FIG. 5), interface 48 (between adjacent edge surfaces 28 and 47) may run at an angle that is e.g. far removed from the perpendicular as shown in FIG. 6. Moreover, the angle of interface 48 does not necessarily have to be constant, again as shown in exemplary embodiment in FIG. 6. (In some such embodiments the angle of interface 48 may decrease as it approaches surface 21 of stripe 20, so that portion 25 may e.g. comprise a laterally-elongated flange portion as shown in FIG. 6.)

Significant advantages can be imparted by such designs. Specifically, in some particular applications, a high-performance first adhesive 20 may be preferentially provided (e.g. in a relatively thin surface layer in lateral edge portions 25) against the surface 11 of substrate liner 10 instead of second adhesive 40 being present in such locations. That is, the area of first surface 21 of first adhesive 20 that is against surface 11 of substrate 10 may be greater than that expected based on the overall amounts of the first and second adhesives in adhesive layer 5. This arrangement will be referred to herein as surface-enrichment of first adhesive 20. It will be appreciated that upon separation of substrate 10 from adhesive layer 5, surface 21 of first adhesive 20 that is thus exposed will be in position to be adhesively bonded to e.g. a surface of a building component. The enrichment of first adhesive 20 at this surface may thus provide enhanced bonding to certain surfaces while minimizing the amount of first adhesive 20 that is used in adhesive layer 5 as a whole. Such surface-enrichment arrangements may be advantageously used in combination with the other arrangements disclosed herein. Surface enrichment can be conveniently characterized e.g. by obtaining, and comparing, the area fraction of first adhesive 20 on first-substrate-side of adhesive layer 5, to the area fraction of first adhesive 20 on the opposite side of adhesive layer 5, as documented in the Working Examples herein.

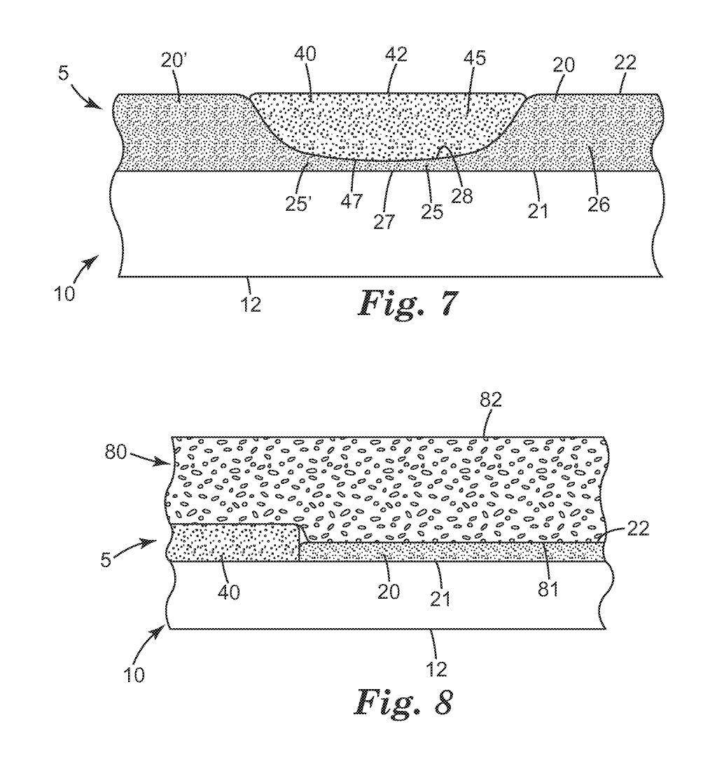

In some embodiments, the general arrangement presented in FIG. 6 may be exploited to an extreme. That is, as shown in exemplary manner in FIG. 7, the lateral edge portions 25 and 25′ of two first stripes 20 and 20′ that laterally flank a second adhesive stripe 40, may extend so far laterally toward each other that they meet and thus completely underlie the second stripe 40. That is, in such cases essentially 100% of the adhesive surface area of adhesive layer 5 that contacts surface 11 of substrate 10, may be supplied by first adhesive 20. Surface-enrichment arrangements are discussed in detail in pending U.S. Patent Application 61/838,533, Attorney Docket No. 74306US002, Entitled “Pressure-Sensitive Adhesive Layers with Surface-Enriched Stripes and Methods of Making”, filed evendate herewith, which is incorporated herein by reference in its entirety.

Bonding to Architectural Paints at Elevated Humidity/Static Shear

It is noted that a skilled artisan might expect that the contributions of two different adhesives in an adhesive layer to the overall performance of the adhesive layer would be generally in proportion to the bonding area which each adhesive presents. In contrast, in the present work it has been found that at least some advantageous effects of the herein-disclosed first adhesives can be out of proportion to the bonding area fraction that the first adhesive provides.

In specific detail, the inventors have found that at least certain adhesives, e.g. silicone-based adhesives, can advantageously preserve the resistance of adhesive layer 5 to shear forces for long times even when exposed to elevated humidity, and even when the adhesive layer is bonded to certain surfaces that comprise e.g. polar moities (e.g. from hydrophilic additives and the like that may be present at the surface). In particular, certain paints, often referred to in the trade as architectural paints, may comprise e.g. such polar moities (which may be present in e.g. various surfactants, additives, etc, that may help improve the stain-removal properties (washability) of the paint). For the purposes of this discussion, by architectural paint is meant a paint that meets the following criteria: when tested in general accordance with the procedure outlined in ASTM D4828-94, the paint exhibits a stain-removal rating of at least 5 (moderate), 7 (large) or 10 (all of stain removed); and, when a representative organic polymeric pressure-sensitive adhesive layer is bonded to the paint and exposed to an Elevated Humidity/Static Shear Test according to the procedures outlined in the Working Examples herein, the adhesive layer exhibits a time to failure of less than 10000 minutes. (For the purposes of performing such a test, the adhesive described herein as Comparative Example PSA-O-1 may be used as a representative organic polymeric adhesive.)

As a standard of reference for this discussion, an exemplary organic polymeric pressure-sensitive adhesive when bonded to an exemplary architectural paint and held in high-humidity conditions may only survive a high-shear load for e.g. about 2500 minutes before failing (as described herein in Comparative Example PSA-O-1-A). An exemplary silicone-based pressure-sensitive adhesive can achieve a threshold level (which has been found to be representative of acceptable performance in the field) of at least about 30000 minutes in these same conditions (as described herein in Comparative Example PSA-S-2-A). Based on their background knowledge in the art, the skilled artisan might expect that an adhesive layer in which the bonding surface comprised a 50/50 ratio of these two adhesives, would exhibit behavior that was proportionally between that of the two individual adhesives. However, as demonstrated in the Working Examples herein, overall bonding-area percentages of silicone adhesive as low as e.g. 23% can still achieve the desired threshold performance level of at least about 30000 minutes in an Elevated Humidity/Static Shear Test. By way of illustration, Working Example 1-1 (Table 1), in which the bonding surface of an adhesive layer 5 that was bonded to an architectural paint comprised approximately 23% by area of a first, silicone-based adhesive, approximately 33% by of a second, area organic polymeric adhesive, and a gap area fraction of approximately 44%, still met the above-mentioned threshold requirement (that is, it appeared to match the performance of the 100% silicone-based adhesive of Comparative Example PSA-S-2-A in this regard).

In broad summary, by any of several arrangements disclosed herein, used individually or in any combination, a significant volume fraction and/or area fraction of a first adhesive, e.g. an adhesive with superior properties for a given application, may be replaced by e.g. a lower-performing adhesive, and/or may be replaced by gaps in which no adhesive is present at all, while still meeting a satisfactory performance threshold. That is, the inventors have demonstrated that the herein-disclosed arrangements can provide performance that is out of proportion to the level at which a first, high-performance adhesive is present in adhesive layer 5. These discoveries allow a significant volume fraction of such a first adhesive to be omitted, while significantly, or even substantially, preserving the properties that would be achieved with an adhesive layer that contained a 100% volume fraction of the first adhesive.

Again, it will be appreciated that such results may be obtained e.g. by replacing a significant volume fraction of a first adhesive with a second adhesive by way of providing a thickness mismatch between the stripes of the two adhesives (as in e.g. Working Example 2-1); and/or, by replacing a significant volume fraction of the first adhesive with a combination of a second adhesive and adhesive-free gaps (as in e.g. Working Example 1-1). Thus by either approach, the volume fraction of a first adhesive layer 5 can be reduced even to e.g. 10-20% if desired, while preserving acceptable properties. It will be further appreciated that the herein-described surface-enrichment effects can augment and/or amplify such effects.

The arrangements disclosed herein may provide advantages in any of a number of situations and applications. By way of illustration, Working Examples are presented herein in which a first adhesive is a silicone-based adhesive that is shown to impart enhanced ability to preserve an adhesive bond to a so-called architectural paint, even in the presence of e.g. high humidity. These results are demonstrated by way of the herein-discussed Elevated Humidity/Static Shear Test. It is emphasized however that the particular adhesives that were chosen, and the particular testing that was done, are illustrative in nature. Any first and second adhesives of differing properties may be used, for any suitable purpose, with the first adhesive being surface-enriched (by any of the arrangements disclosed herein, alone or in any combination) to achieve any desired end.

Pressure-Sensitive Adhesives

First adhesive 20 and second adhesive 40 are both pressure-sensitive adhesives. (While the simplest example of a two-adhesive system is discussed herein, it will be appreciated that third, fourth, or even more adhesives can be present, if desired.) The only requirement is that first and second adhesives possess one property in which they differ from each other (specifically, some e.g. intensive property other than extensive (e.g., geometric) properties such as width and thickness). A property in which the first and second adhesives might differ might be (but is not limited to) one or more of melting point, glass transition temperature, elastic modulus, peel strength, shear strength, hardness, moisture-vapor transmission, water-repellency, oil absorption, solubility in water and/or in organic solvents, temperature resistance, UV-resistance, and so on. It will be appreciated such a difference in properties might be achieved e.g. by a difference in composition; however, even adhesives of very similar composition might exhibit different properties e.g. by way of having been exposed to a different processing history. That is, the first and second adhesive (whether similar in composition or not) might differ in e.g. percent crystallinity, free volume, crosslink density, and so on. In some embodiments, one or both of first and second adhesives 20 and 40 may be a repositionable adhesive. In alternative embodiments, neither of first and second adhesives 20 and 40 are repositionable.

Pressure-sensitive adhesives are normally tacky at room temperature and can be adhered to a surface by application of, at most, light finger pressure and thus may be distinguished from other types of adhesives that are not pressure-sensitive. A general description of pressure-sensitive adhesives may be found in the Encyclopedia of Polymer Science and Engineering, Vol. 13, Wiley-Interscience Publishers (New York, 1988). Additional description of pressure-sensitive adhesives may be found in the Encyclopedia of Polymer Science and Technology, Vol. 1, Interscience Publishers (New York, 1964). In at least some embodiments, a pressure-sensitive adhesive may meet the Dahlquist criterion described in Handbook of Pressure-Sensitive Adhesive Technology, D. Satas, 2nd ed., page 172 (1989). This criterion defines a pressure-sensitive adhesive as one having a one-second creep compliance of greater than 1×10⁻⁶ cm²/dyne at its use temperature (for example, at temperatures in a range of from 15° C. to 35° C.).

Any suitable pressure-sensitive adhesive of any suitable composition and with any suitable properties may be used for either or both of first and second pressure-sensitive adhesives 20 and 40. In some embodiments, at least one of first and second adhesives 20 or 40 is a silicone-based pressure-sensitive adhesive. In some embodiments, first adhesive 20 is a first silicone-based adhesive with a first set of properties, and second adhesive 40 is a second silicone-based adhesive with a second set of properties (and that may differ in composition from the first adhesive). Such adhesives typically include at least one silicone elastomeric polymer, and that may contain other optional components such as tackifying resins. The silicone elastomeric polymer may be a silicone block copolymer elastomer comprising hard segments that each comprise at least one polar moiety. By a polar moiety is meant a urea linkage, an oxamide linkage, an amide linkage, a urethane linkage, or a urethane-urea linkage. Thus, suitable silicone block copolymer elastomers include for example, urea-based silicone copolymers, oxamide-based silicone copolymers, amide-based silicone copolymers, urethane-based silicone copolymers, and mixtures thereof. Such silicone-based pressure sensitive adhesives are described in detail in pending U.S. Patent Application 61/838,504, Attorney Docket No. 71412US002, Entitled “Article Comprising Pressure-Sensitive Adhesive Stripes”, filed evendate herewith which is incorporated herein by reference in its entirety. Other silicone-based adhesives may be those based e.g. on thermally curable (e.g., platinum-cured, peroxide-cured, moisture-cured silicone polymers, etc.), as are well-known to the skilled artisan. Such silicones may not necessarily comprise any of the above-listed hard segments.

Silicone-based pressure-sensitive adhesive compositions (whether relying e.g. on a block copolymer with hard segments, or any other type of silicone elastomer) may often include an MQ tackifying resin. Silicone-based adhesives, of any of the above-discussed types and variations, may be provided in any suitable form to be formed into stripes 20 and/or 40. For example, such an adhesive may be provided in the form of a precursor liquid that is a flowable liquid that can be deposited onto substrate 10 to form stripes of the precursor liquid, which precursor can then be transformed into the silicone-based adhesive in its final form. Thus, a precursor flowable liquid might be e.g. a 100% solids mixture suitable for e.g. hot melt coating, or a water-borne emulsion (e.g. latex), or a solution in one or more suitable solvents, as discussed later herein.

In some embodiments, at least one of first and second adhesives 20 or 40 is an organic polymeric pressure-sensitive adhesive. In some embodiments, first adhesive 20 is a first organic polymeric adhesive with a first set of properties, and second adhesive 40 is a second organic polymeric adhesive with a second set of properties (and that may differ in composition from the first adhesive). An organic polymeric pressure-sensitive adhesive by definition includes less than 10 weight percent of a silicone-based pressure-sensitive adhesive (dry weight basis). In various embodiments, such an adhesive may comprise less than 4, 2 or 1% of a silicone-based adhesive. In many embodiments, such an adhesive will contain substantially no (i.e., less than 0.2 weight percent) of a silicone-based pressure-sensitive adhesive. It will however be appreciated that in some circumstances such an adhesive may comprise some small amount (e.g., less than 2.0, 1.0, 0.4, 0.2, 0.1, or 0.05 weight percent) of silicone-containing additive (e.g., emulsifier, plasticizer, stabilizer, wetting agent, etc.). Such circumstances, in which one or more silicone-containing additive(s) is/are present for some purpose other than imparting pressure-sensitive properties to the adhesive, cannot cause such an adhesive to be considered to be a silicone-based adhesive.

By organic polymeric pressure-sensitive adhesive is meant that the adhesive is based on at least one organic polymeric elastomer (optionally in combination with other components such as one or more tackifying resins). It will be appreciated that an organic polymeric adhesive does not have to be based on an organic polymeric elastomer that is purely hydrocarbon (although this may be done if desired). Rather, the presence of heteroatoms (such as O, N, Cl, and so on) is permitted (whether in the backbone of the elastomer chain and/or in a sidechain thereof), as long as the presence of the specific heteroatom Si is minimized according to the criteria outlined above.

General categories of exemplary materials which may be suitable for use in an organic polymeric pressure-sensitive adhesive include e.g. elastomeric polymers based on natural rubber; synthetic rubber (e.g., butyl rubber, nitrile rubber, polysulfide rubber); block copolymers; the reaction product of acrylate and/or methacrylate materials; and so on. (As used herein, terms such as (meth)acrylate, (meth(acrylic), and the like, refer to both acrylic/acrylate, and methacrylic/methacrylate, monomer, oligomers, and polymers derived therefrom). Specific polymers and/or copolymers and/or monomer units suitable for inclusion in such an elastomeric polymer of such an adhesive may include, but are not limited to: polyvinyl ethers, polyisoprenes, butyl rubbers, polyisobutylenes, polychloroprenes, butadiene-acrylonitrile polymers, styrene-isoprene, styrene-butylene, and styrene-isoprene-styrene block copolymers, ethylene-propylene-diene polymers, styrene-butadiene polymers, styrene polymers, poly-alpha-olefins, amorphous polyolefins, ethylene vinyl acetates, polyurethanes, silicone-urea polymers, polyvinylpyrrolidones, and any combinations (blends, copolymers, etc.) thereof. Examples of suitable (meth)acrylic materials include polymers of alkyl acrylate or methacrylate monomers such as e.g. methyl methacrylate, ethyl methacrylate, n-butyl methacrylate, methyl acrylate, ethyl acrylate, n-butyl acrylate, iso-octyl acrylate, iso-nonyl acrylate, 2-ethyl-hexyl acrylate, decyl acrylate, dodecyl acrylate, n-butyl acrylate, hexyl acrylate, octadecyl acrylate, octadecyl methacrylate, acrylic acid, methacrylic acid, acrylonitrile, and combinations thereof. Examples of suitable commercially available block copolymers include those available under the trade designation KRATON from Kraton Polymers, Houston, Tex. Any of these or other suitable materials may be used in any desired combination. A general description of some useful organic polymeric pressure-sensitive adhesives may be found in the Encyclopedia of Polymer Science and Engineering, Vol. 13, Wiley-Interscience Publishers (New York, 1988). Additional descriptions of some useful organic polymeric pressure-sensitive adhesives may be found in the Encyclopedia of Polymer Science and Technology, Vol. 1, Interscience Publishers (New York, 1964).

If desired, a tackifying resin may be included in an organic polymeric adhesive. (Those of ordinary skill will appreciate that some elastomers may be self-tacky and thus may require little or no added tackifying resin.) Any suitable tackifying resin or combination thereof may be used. Suitable tackifying resins may include e.g. wood rosins and hydrogenated derivatives thereof, tall oil rosins, terpene resins, phenolic resins, polyaromatics, petroleum-based resins, (e.g. aliphatic C5 olefin-derived resins) and so on. Additionally, pressure-sensitive adhesive 40 can contain additives such as plasticizers, fillers, antioxidants, stabilizers, pigments, and the like.

It may be convenient (e.g., for masking and/or stretch-release uses), that the components of an organic pressure-sensitive adhesive be chosen so as to provide good adhesion to a surface, while also being removable under moderate force without leaving a residue, e.g. a visible residue. In certain embodiments, a pressure-sensitive adhesive may be natural-rubber-based, meaning that a natural rubber elastomer or elastomers make up at least about 70 wt. % of the elastomeric components of the adhesive (not including any filler, tackifying resin, etc.). In some embodiments, the organic polymeric elastomer may be a hydrocarbon block copolymer elastomer (e.g., of the general type available under the trade designation KRATON from Kraton Polymers, Houston, Tex.). In specific embodiments, the block copolymer elastomer may be e.g. a styrene-butadiene-styrene (SBS) or a styrene-isoprene-styrene (SIS) block copolymer, a blend of the two, blend of either of both of these with a natural rubber elastomer, and so on (along with e.g. at least one tackifying resin).

Organic polymeric adhesives, of any of the above-discussed types and variations, may be provided in any suitable form to be formed into stripes 20 and/or 40. For example, such an adhesive may be provided in the form of a precursor liquid that is a flowable liquid that can be deposited onto a substrate 10 to form stripes of the precursor liquid, which precursor can then be transformed into the organic polymeric adhesive in its final form. Thus, a precursor flowable liquid might be e.g. a 100% solids mixture suitable for e.g. hot melt coating, or a water-borne emulsion (e.g. latex), or a solution in one or more suitable solvents, as discussed later herein.

First Substrate

First substrate 10 can be any suitable substrate upon which is it desired to dispose (e.g., by coating) adhesive layer 5, whether temporarily or permanently. In many embodiments, substrate 10 may be a release liner. Such a release liner 10 may comprise a release surface on first major surface 11, which release surface is suitable for releasing of a pressure-sensitive adhesive therefrom. Release liner 10 may optionally comprise a release surface, on second major surface 12. In particular embodiments, the release surface on second major surface 12 may comprise the same, or different, release properties from those of first major surface 11 (in the latter case, liner 10 will thus be a so-called differential-release liner, as will be well understood by the ordinary artisan).

Release surface 11 (and release surface 12, if present) can be provided by any suitable material (or, by any suitable treatment of the surface of the material of which release liner 10 is made). In cases in which adhesive layer 5 comprises e.g. organic polymeric adhesives with little or no silicone-based adhesives, such a release surface might be e.g. any suitable coating, for example wax or the like. Or, any suitable high molecular weight polymeric layer (e.g., coating) might be used, e.g. a polyolefin layer such as polyethylene and so on. It will be appreciated that numerous layers and treatments will be suitable for such use.

If adhesive layer 5 comprises a significant amount of silicone-based adhesive, it may be advantageous to provide release surface 11 with a composition that enhances the ability of a silicone-based adhesive to be released therefrom. Fluorinated materials are often used for such purposes. Examples of potentially suitable materials include, but are not limited to, fluorinated materials such as e.g. fluorochemicals, fluorocarbons, fluorosilicones, perfluoropolyethers, perfluorinated polyurethanes, and combinations thereof. In particular embodiments, the fluorinated release surface is provided by a fluorosilicone polymer. Particularly useful fluorosilicone release coatings may include the reaction product of a fluorosilicone polymer, an organohydrogenpolysiloxane crosslinking agent and a platinum-containing catalyst. A number of useful commercially available fluorosilicone polymers are available from Dow Corning Corp. (Midland, Mich.) under the SYL-OFF and the SYL-OFF ADVANTAGE series of trade designations including, e.g., SYL-OFF Q2-7786 and SYL-OFF Q2-7785. One example of a useful release liner is a fluoroalkyl silicone polycoated paper.

Release liner 10 can be of a variety of forms including, e.g., sheet, web, tape, and film. Examples of suitable materials include, e.g., paper (e.g., kraft paper), polymer films (e.g., polyethylene, polypropylene and polyester), composite liners, and combinations thereof. One example of a useful release liner is a fluoroalkyl silicone polycoated paper. Release liners can optionally include a variety of markings and indicia including, e.g., lines, art work, brand indicia, and other information. Adhesive layer 5 can be provided across substantially the entirety of the width of release liner 10; or, a border may be provided along one or both edges of release liner 10 in which adhesive layer 5 is not present, if desired. In some embodiments, substrate 10 may not be a release liner. In such embodiments, adhesive layer 5 may be bonded permanently to substrate 10 (meaning that the adhesive layer and the substrate cannot be removed from each other without unacceptably damaging or destroying one of both of them). In such embodiments, substrate 10 can be any backing (i.e., a tape backing) suitable for making any suitable kind of tape (masking tape, sealing tape, strapping tape, filament tape, packaging tape, duct tape, electrical tape, medical/surgical tape, and so on). Backing 10 can take any suitable form including, e.g. polymer films, paper, cardboard, stock card, woven and nonwoven webs, fiber reinforced films, foams, composite film-foams, and combinations thereof. Backing 10 may be comprised of any suitable material including e.g. fibers, cellulose, cellophane, wood, foam, and synthetic polymeric materials including, e.g., polyolefins (e.g., polyethylene, polypropylene, and copolymers and blends thereof); vinyl copolymers (e.g., polyvinyl chlorides, polyvinyl acetates); olefinic copolymers (e.g., ethylene/methacrylate copolymers, ethylene/vinyl acetate copolymers, acrylonitrile-butadiene-styrene copolymers, and so on); acrylic polymers and copolymers; and polyurethanes. Blends of any of these may be used. In particular embodiments, oriented (e.g., uniaxially or biaxially oriented) materials such as e.g. biaxially-oriented polypropylene may be used. Regardless of the specific nature and purpose of substrate 10, adhesive layer 5 can be provided across substantially the entirety of the width of substrate 10; or, a border may be provided along one or both edges of substrate 10 in which adhesive layer 5 is not present, if desired.

Secondary Substrate

In some embodiments, the side of primary adhesive layer 5 that is opposite substrate 10 can be bonded to a secondary substrate 80, which bonding may be temporary or permanent as desired. As such, a secondary substrate 80 might be any of the release liners described above. In other embodiments, such a substrate can be any backing such as any of the above-described tape backings.

In some embodiments, the herein-described adhesive layer 5 may be used to make a stretch-releasable article, e.g. article 90 as shown in FIG. 3. In such embodiments, backing 80 may be a highly extensible backing to allow the stretch-releasing properties of the article to be utilized. The term “highly extensible” as used herein means that when backing 80 is stretched along its long axis, an elongation of at least about 150% is achieved without rupture or breakage of backing 80. In such embodiments, backing 80 may be capable of achieving an elongation of e.g. about 350, 550, or 750%.

Suitable highly extensible backings may include e.g. a single layer of foam, multiple layers of foam, a single layer of film, multiple layers of film and combinations thereof. Such materials may be selected to optimize properties such as conformability and resiliency, which are useful when the article is to be adhered to surfaces having surface irregularities, e.g., painted drywall. Such a foam or film layer may be prepared from a variety of thermoplastic polymers including, e.g., polyolefins, vinyl polymers and/or copolymers olefinic copolymers, acrylic polymers and copolymers; polyurethanes; and so on. Backings for stretch-release articles are described in further detail in U.S. Pat. No. 8,344,037 (Sheridan) which is incorporated by reference in its entirety herein. Backing 80 may comprise any suitable thickness including, e.g., from about 20 microns to about 1 mm. In the particular case in which backing 80 is a highly extensible foam e.g. for a stretch-release article, backing 80 may suitably be thicker (e.g., 0.5 mm or so) than the case in which backing 80 is e.g. biaxially oriented polypropylene e.g. for sealing tape applications. To improve the adhesion of layer 5 to backing 80, a major surface of backing 80 can be pretreated prior to disposing adhesive layer 5 on that surface of backing 80. Examples of suitable treatments include corona discharge, plasma discharge, flame treatment, electron beam irradiation, ultraviolet radiation, acid etching, chemical priming and combinations thereof.

As mentioned, in some embodiments it may be particularly advantageous that backing 80 comprise a relatively thick and conformable polymeric foam. In particular, such a polymeric foam may comprise sufficient thickness and conformability so as to be able to locally conform to adhesive stripes that may differ in thickness by up to e.g. 20, 40, 60, or 80 microns or more and that may comprise widths of from e.g. about 0.5 to about 4 mm. (A construction in which an adhesive layer 5 comprising relatively thin first adhesive stripes 20 and relatively thick second adhesive stripes 40 is laminated to a relatively thick and conformable polymeric foam substrate 80 is shown in exemplary embodiment in FIG. 8.) In particular embodiments, such a substrate 80 may be sufficiently thick and locally conformable that a first surface 81 of the substrate can satisfactorily conform to stripes of mismatched thicknesses, while a second, oppositely-facing surface 82 of the substrate may remain substantially planar (as illustrated in FIG. 8). In various embodiments, backing 80 may comprise a polymeric foam with a thickness of at least about 0.2, 0.4, 0.8, or 1.2 mm. In further embodiments, such a polymeric foam may comprise a thickness of at most about 8, 4, or 2 mm. In various embodiments, such a polymeric foam may comprise a density of at least about 1, 2, 4 or 6 pounds per cubic foot. In further embodiments, such a polymeric foam may comprise a density of at most about 30, 20 or 10 pounds per cubic foot. If a polymer film is present (e.g. laminated) on the surface of the foam backing to which adhesive layer 5 is to be bonded, such a film may advantageously be thin and conformable to allow the multilayer backing to conform to the stripes.

Although in many situations it may be convenient to use a backing 80 as described herein, in some embodiments adhesive layer 5 may be used as a stretch-release article, without being laminated to e.g. a highly extensible backing. In such cases, adhesive layer 5 may be e.g. thick enough to handle and to provide other useful properties. Thus, in such embodiments adhesive layer 5 may comprise an average thickness of from at least about 5, 10, 15 or 20 mils, to about 100, 80, 60, or 40 mils. In such embodiments, adhesive layer 5 should of course comprise sufficient mechanical integrity to be handleable. Thus, in at least some such embodiments the stripes 20 and 40 may contact each other rather than having gaps in between; and, they should comprise sufficient bonding of the adjacent stripes to each other to provide adhesive layer 5 as a whole with sufficient mechanical integrity.

Methods of Making

Stripes of first adhesive 20 and second adhesive 40 may be deposited on major surface 11 of substrate 10 e.g. by any method that allows the acceptable formation of stripes as disclosed herein. That is, a precursor to first adhesive 20, and a precursor to second adhesive 40, may each be deposited onto substrate 10 as a flowable liquid in any suitable form. For example, such a flowable liquid might be a 100% solids composition (e.g. a hot-melt coating composition) that is deposited followed e.g. by the reaction of functional groups (e.g., crosslinking, polymerization, oligomerization, etc.) to impart the desired adhesive properties to the final product. Or, such a flowable liquid might be a water-borne coating (e.g., a latex or emulsion), that is deposited followed e.g. by drying to remove the water, and by any reaction/crosslinking if needed. In particular embodiments, first adhesive 20 and second adhesive 40 may be solvent coated—that is, each adhesive may be solubilized in an appropriate solvent (or solvent mixture) to form a coating solution that may be coated onto substrate 10 followed by removal of the solvent(s), and by any reaction/crosslinking etc. if needed. In other words, a coating solution of each adhesive may be formed by dissolving the elastomer(s) (and tackifier(s) if present) in a solution, along with any other desired additives or ingredients, with one or more solvents that can adequately solubilize the ingredients. In such embodiments, the precursor flowable liquids for the first and second adhesives by definition are not 100% solids compositions (e.g., hot melt coatable and/or extrudable compositions) and the resulting article comprises a solvent-coated adhesive layer rather than e.g. a hot-melt-coated layer or extruded layer.

In some embodiments, each stripe of an adhesive can be formed by expelling the precursor flowable liquid (e.g., coating solution) through an opening in a coating die, onto a moving surface 11 of substrate 10. Multiple stripes of e.g. first adhesive 20 can be obtained by simultaneously expelling the first coating solution through multiple, laterally-spaced openings of the die, which may be achieved e.g. by the use of a slot die with one or more shims provided therein to block off portions of the slot and to leave other portions of the slot open for the coating solution to pass therethrough. The same can be done for second adhesive 40 (so that the streams of the first liquid, and the streams of the second liquid, are expelled simultaneously from the various openings, and so that the streams of both liquids land essentially simultaneously on the surface of the substrate). Generally alternating stripes of first adhesive 20 and second adhesive 40 may be achieved by variations on the above general approaches. The dimensions of the openings, the flowrates of the various streams, and so on, can be manipulated so as to deposit the various streams at desired thicknesses so as to achieve any desired thickness of the resulting adhesive stripes. Likewise, the placement and dimensions of the openings can be manipulated so as to provide adhesive-free gaps between at least some of the resulting adhesive stripes, as desired.

Each precursor liquid that is deposited (coated) onto surface 11 of substrate 10 (e.g., as a stripe that is elongated in the direction of motion of substrate 10), can then be processed (e.g., by passing substrate 10 through an oven) to leave behind each final adhesive composition as an stripe of the final desired thickness, width, pitch, and so on. Of course, if any reactive/functional components are present in the precursor liquid, they may react, polymerize, etc., to provide the final desired product, either instead of, or in addition to, any solidification that occurs by way of removal of a coating solvent or of water. Such reaction may be promoted by e.g. temperature, radiation, or any commonly used method.

Once the coating/solidification is process is complete (that is, when the stripes of adhesive 20 and 40 are in their final form so as to collectively comprise adhesive layer 5 upon major surface 11 of substrate 10), substrate 10 bearing adhesive layer 5 thereupon can be e.g. wound and stored as a continuous roll until ready for further processing. As such, substrate 10 may comprise a release coating, e.g. a fluorosilicone release coating, on surface 12 to ensure that the roll can be unwound as desired. Or, substrate 10 bearing adhesive layer 5 thereupon can be further processed without being rolled up and/or stored, as desired. In any case, in some embodiments adhesive layer 5 can be adhesively bonded (e.g., laminated) to secondary substrate 80 e.g. to form a pressure-sensitive adhesive tape. In some embodiments such an adhesive tape can be a single-faced (sided) tape. In other embodiments, a second adhesive layer 115 (and a second release liner 110, if desired) can be laminated to the opposite side of substrate 80, to form a double-faced adhesive tape. If desired, substrate 80 can be highly extensible so that the formed tape (whether single or double faced) can serve as a stretch-releasable adhesive tape.

### LIST OF EXEMPLARY EMBODIMENTS

### Embodiment 1

An article comprising: a first substrate that is a release liner comprising a release surface on at least a first major surface thereof; a secondary substrate that is a conformal backing and that comprises a first major surface thereof; a primary adhesive layer comprising a first major surface that is in contact with the first major surface of the release liner and a second major surface that is in contact with the first major surface of the conformal backing, wherein the primary adhesive layer comprises a plurality of stripes of a first pressure-sensitive adhesive and of a second pressure-sensitive adhesive, arranged in a generally alternating pattern across at least a lateral extent of the release liner; and wherein an average thickness of the stripes of the second pressure-sensitive adhesive is greater than an average thickness of the stripes of the first pressure-sensitive adhesive by a factor of at least 1.2 and wherein a thickness of the conformal backing is at least about four times a thickness of the primary adhesive layer.

### Embodiment 2

The article of embodiment 1, wherein the first pressure-sensitive adhesive is a silicone-based adhesive that comprises a silicone elastomer, and wherein the second pressure-sensitive adhesive is an organic polymeric pressure-sensitive adhesive.

### Embodiment 3

The article of embodiment 2, wherein the silicone elastomer is a silicone block copolymer elastomer selected from the group consisting of urea-based silicone block copolymers, oxamide-based silicone block copolymers, amide-based silicone block copolymers, and urethane-based silicone block copolymers, and mixtures and blends thereof.

### Embodiment 4

The article of any of embodiments 2-3, wherein the organic polymeric pressure-sensitive adhesive comprises an organic elastomer selected from the group consisting of styrenic block copolymer elastomers, natural rubber elastomers, (meth)acrylate elastomers, and mixtures and blends thereof.

### Embodiment 5

The article of any of embodiments 1-4 wherein at least selected stripes of the first pressure-sensitive adhesive each extend continuously from a first major surface that is in contact with the release surface of the first substrate, to a second, oppositely-facing major surface that is adhesively bonded to the first major surface of the conformal backing.

### Embodiment 6

The article of any of embodiments 1-5, wherein the conformal backing is a highly extensible tape backing and wherein the tape backing and the primary adhesive layer collectively provide a length of stretch-releasable adhesive tape.

### Embodiment 7

The article of embodiment 6, further comprising a secondary adhesive layer disposed on a second major side of the tape backing that is oppositely-facing from the first major side of the tape backing, wherein the tape backing and the primary and secondary adhesive layers collectively provide a double-faced stretch-releasable adhesive tape.

### Embodiment 8

The article of any of embodiments 1-7, wherein at least selected pairs of laterally adjacent stripes of the first pressure-sensitive adhesive and the second pressure-sensitive adhesive each comprise a gap between the first pressure-sensitive adhesive stripe of the pair and the second pressure-sensitive adhesive stripe of the pair, which gap comprises an exposed portion of the release surface of the first substrate, which exposed portion of the release surface is not in contact with any pressure-sensitive adhesive.

### Embodiment 9

The article of embodiment 8, wherein the primary adhesive layer comprises a gap area fraction of up to about 50%.

### Embodiment 10

The article of any of embodiments 1-9, wherein at least selected pairs of laterally adjacent stripes of the first pressure-sensitive adhesive and the second pressure-sensitive adhesive each comprise a minor surface of a lateral edge of the first pressure-sensitive adhesive stripe of the pair that is in generally lateral contact with a minor surface of a lateral edge of the second pressure-sensitive adhesive stripe of the pair.

### Embodiment 11

The article of any of embodiments 1-10, wherein at least selected pairs of laterally adjacent stripes of the first pressure-sensitive adhesive and the second pressure-sensitive adhesive are each configured so that a lateral edge portion of the first pressure-sensitive adhesive stripe of the pair comprises a first major surface that is in contact with the release surface of the first substrate and so that the lateral edge portion of the first pressure-sensitive adhesive further comprises a second, generally oppositely-facing major surface that is in contact with a major surface of a lateral edge portion of the second pressure-sensitive adhesive stripe of the pair, wherein the lateral edge portion of the first pressure-sensitive adhesive stripe inwardly underlies the lateral edge portion of the second pressure-sensitive adhesive stripe.

### Embodiment 12

The article of any of embodiments 1-11, wherein the first pressure-sensitive adhesive provides a volume fraction of the primary adhesive layer that is from greater than 10%, to about 55%.

### Embodiment 13

The article of any of embodiments 1-12, wherein the thickness of the conformal backing is at least about eight times the thickness of the primary adhesive layer.

### Embodiment 14

The article of any of embodiments 1-13, wherein the thickness of the conformal backing is at least about twelve times the thickness of the primary adhesive layer.

### Embodiment 15

The article any of embodiments 1-14, wherein the thickness of the conformal backing is at least about sixteen times the thickness of the primary adhesive layer.

### Embodiment 16

The article of any of embodiments 1-15, wherein the average thickness of the stripes of the second pressure-sensitive adhesive is greater than an average thickness of the stripes of the first pressure-sensitive adhesive by a factor of at least 1.6.

### Embodiment 17

The article of any of embodiments 1-16, wherein the average thickness of the stripes of the second pressure-sensitive adhesive is greater than an average thickness of the stripes of the first pressure-sensitive adhesive by a factor of at least 2.0.

### Embodiment 18

The article of any of embodiments 1-17, wherein the average thickness of the stripes of the second pressure-sensitive adhesive is greater than an average thickness of the stripes of the first pressure-sensitive adhesive by a factor of at least 2.5.

### Embodiment 19

The article of any of embodiments 1-18, wherein the average thickness of the stripes of the second pressure-sensitive adhesive is greater than an average thickness of the stripes of the first pressure-sensitive adhesive by a factor of at least 3.0.

### Embodiment 20

The article of any of embodiments 1-19, wherein the average thickness of the stripes of the second pressure-sensitive adhesive is greater than an average thickness of the stripes of the first pressure-sensitive adhesive by a factor of about 3.5.

### Embodiment 21

An article comprising: a first substrate that comprises a first major surface thereof; a secondary substrate that comprises a first major surface thereof; a primary adhesive layer comprising a first major surface that is in contact with the first major surface of the first substrate and a second major surface that is in contact with the first major surface of the secondary substrate, wherein the primary adhesive layer comprises a plurality of stripes of a first, silicone-based pressure-sensitive adhesive and of a second, organic polymeric pressure-sensitive adhesive, arranged in a generally alternating pattern across at least a lateral extent of the release liner; wherein the stripes of the first, silicone-based pressure-sensitive adhesive provide a volume fraction of the primary adhesive layer of from greater than about 10%, to about 55%, and wherein the primary adhesive layer exhibits an Elevated Humidity/Static Shear Test result of >30000 minutes.

### Embodiment 22

The article of embodiment 21, wherein the stripes of the first, silicone-based pressure-sensitive adhesive provide a volume fraction of the primary adhesive layer of from about 13% to about 52%.

### Embodiment 23

The article of embodiment 21, wherein the stripes of the first, silicone-based pressure-sensitive adhesive provide a volume fraction of the primary adhesive layer of from about 15% to about 50%.

### Embodiment 24

The article of embodiment 21, comprising the features of any of embodiments 1-20.

### EXAMPLES

### Test Procedures

Test procedures used in the Examples include the following.

Measurement of Stripe Parameters

To perform thickness measurements of stripes, samples were cut with a sharp razorblade at random locations and thicknesses determined optically via an Olympus Optical Microscope. All measurements were recorded in mils (thousandths of an inch).

Stripe width, stripe pitch (center-to-center distance), and gap width (i.e., the distance between the nearest edges of any two neighboring stripes of differing composition, or between the nearest edges of any two neighboring sub-stripes of the same composition) were measured using an Olympus Optical Microscope. At least three measurements were taken at random locations on the sample and averaged. In more detail, the width of stripes with gaps therebetween (e.g. that resembled the exemplary depiction of FIG. 1) could be easily measured. The width of stripes that had lateral edges that contacted each other (e.g., stripes that resembled the exemplary depiction of FIG. 5) could likewise be easily measured since the interfaces between adjacent stripes could be readily identified. Details of measurement of widths (and the calculation of resulting area and volume fractions) in the special case in which surface-enrichment was present, can be found in the disclosure of pending U.S. Patent Application 61/838,533, Attorney Docket No. 74306US002, Entitled “Pressure-Sensitive Adhesive Layers with Surface-Enriched Stripes and Methods of Making”, filed evendate herewith.

Area Fractions and Volume Fractions

The various area fractions described herein could be straightforwardly calculated from the average widths of the stripes (and gaps if present). By way of a specific example, for a 20/(40/40) . . . pattern that included gaps between the various stripes, and sub-stripes, such calculations would take into account the area contributions of one 20 stripe, two 40 stripes, and three gaps. As discussed in detail earlier herein, the overall area fraction parameter for an adhesive included the effect of any gaps present, while the adhesive-only area fraction was indicative of the relative area proportions of the first and second adhesives on an adhesive-only basis, irrespective of the presence or absence of gaps. (In designs in which no gaps were present, the “adhesive-only” and “overall” area fractions were substantially equal to each other; that is, in such cases they could be considered to be equivalent to each other.) For adhesive layers with silicone enrichment (e.g., of the general type shown in FIGS. 6-7), the liner-side stripe width and the opposite-side stripe width could be obtained, and could then be used to calculate the liner-side and opposite-side area fractions. (Since no gaps were present, each such area fraction could be equivalently considered to be an adhesive-only and an overall area fraction).

Volume fractions could also be straightforwardly calculated from the average widths of the stripes (and gaps if present), by further taking into account the thicknesses of the adhesive stripes (and of any gaps therebetween). As mentioned previously, gaps that were located in between neighboring stripes of differing thicknesses were assumed to have thicknesses that were halfway between the thicknesses of the neighboring stripes, for purposes of calculation.

Elevated Humidity/Static Shear Test Method

Elevated Humidity/Static Shear Test Method tests were performed in generally similar manner to those outlined in U.S. Patent Application No. 61/383,504, Attorney Docket No. 71412US002, Entitled “Article Comprising Pressure-Sensitive Adhesive Stripes”, filed evendate herewith.

### Materials

Release Liner and Tape Backing

Fluorosilicone release liner of the general type designated as SYL-OFF Q2-7785, and multilayer composite foam laminate backing (thickness approximately 36 mils), were obtained, of the types described in the Examples section of U.S. Pat. No. 8,344,037 (Sherman).

Organic Polymeric Pressure-Sensitive Adhesive Coating Solution

An organic polymeric pressure-sensitive adhesive composition comprising styrene-butadiene-styrene block copolymer elastomers was prepared generally according to composition D of U.S. Pat. No. 6,231,962 (Bries). The solution as prepared comprised this adhesive composition at approximately 43 wt. % (total) solids in toluene, and was diluted with toluene to approximately 35% solids to form a coating solution. The coating solution exhibited a viscosity (Brookfield LVT, #3 spindle, 6 rpm, for this and all other viscosities listed here) in the range of approximately 1500 cP. This adhesive was designated as PSA-O-1. All stripes of organic polymeric adhesive in the following Working Examples used this adhesive.

Silicone-Based Pressure-Sensitive Adhesive Coating Solution—SPU

A pressure-sensitive adhesive composition was prepared that comprised a silicone-polyurea (SPU) elastomer in combination with a functional MQ resin. The composition was prepared generally according to Example 27 of U.S. Pat. No. 6,569,521 (Sheridan), with the difference that the ratio of components was altered to achieve a pressure-sensitive adhesive composition with MW PDMS diamine/moles Dytek A polyamine/% by weight MQ resin of 33000/0.5/50 (that is, with the silicone-polyurea elastomer and the MQ resin being at an approximately 50/50 weight ratio). The coating solution comprised this adhesive composition at approximately 30 wt. % total solids in a 70/30 (wt. %) blend of toluene/isopropanol. The coating solution exhibited a viscosity of approximately 8700 cP. This adhesive was designated as PSA-S-1.

Silicone-Based Pressure-Sensitive Adhesive Precursor Coating Solution—SPOx

A pressure-sensitive adhesive composition was obtained that comprised a silicone-polyoxamide (SPOx) elastomer in combination with a functional MQ resin. The silicone-polyoxamide elastomer was believed to be similar in structure and properties to the elastomer described as “PSA 2” in the Working Examples of U.S. Patent Application Publication No. 2009/0229732 (Determan). The functional MQ resin was procured from GE under the trade designation SR-545 (as was the MQ resin used in PSA-S-1).

The silicone-polyoxamide elastomer and the MQ resin were at a 50/50 weight ratio. The coating solution comprised this adhesive composition at approximately 35 wt. % total solids in a 60/20/20 (wt. %) blend of ethyl acetate/isopropanol/toluene. The coating solution exhibited a viscosity of approximately 7600 cP. This adhesive was designated as PSA-S-2. All of the stripes of silicone-based adhesives in the following Tables of Working Examples used this silicone-based adhesive, except for those Examples specifically noted as using PSA-S-1.

### Coating Process

Representative Coating Process

The coating solutions were wet coated on the SYL-OFF Q2-7785 release liner in stripes using a dual layer slot die. The two layers of the slot die were fed from separate manifolds (one to feed a first coating solution, the other to feed a second coating solution, with separate shims being provided for each manifold/slot layer). Each shim comprised openings of desired width and spacing to expel coating solution therethrough so as to form stripes of that coating solution of the desired width and pitch. The two shims were registered in relation to each other so as to deposit stripes in a generally alternating pattern as desired. In typical experiments, the total width of the coating area was approximately 2 inches.

Representative experiments were conducted with a first coating solution comprising PSA-O-1 (organic polymeric adhesive) and with a second coating solution comprising PSA-S-1 (silicone-based adhesive). The two coating solutions were fed to their respective slot layers at a feed rate of approximately 22 cc/min (in a few cases, the flowrate of the PSA-S-1 coating solution was kept at 22 cc/min and the flowrate of the PSA-O-1 coating solution was increased to 44 cc/min). Coating experiments were done at various line speeds, including 10, 20, 30, 40 and 50 feet per minute. After coating, the stripe-coated release liner was passed through a 3-zone forced air oven with zones operating respectively at approximately 57° C., 74° C. and 85° C. zone temperatures to yield a dry coating of the pressure-sensitive adhesive. After drying, the release liner, bearing the dried adhesive layer on the fluorosilicone release surface thereof, was rolled up and stored at ambient conditions until used.

Variations

Numerous variations of the above Representative Coating Process were done, including experiments with PSA-S-2 as the second coating solution. The method in which the coating solutions were delivered were also varied; e.g., apparatus was used in which flow passages were integrated as part of the die itself (in generally similar manner to the arrangements described previously herein), and in which the number and design of die shims were varied. It is believed that these variations in the particular manner in which the coating solutions were passed through the interior of the die did not significantly affect the behavior of the coating solutions once the solutions were coated on the release liner. That is, they did not appear to significantly affect the herein-described preferential flow/wetting and displacement of one coating solution by another.

Converting

A release liner bearing a primary adhesive layer thereon was typically stored in roll form until used. Then, the liner was unrolled (to expose the surface of the primary adhesive opposite the release liner) and the exposed surface of the primary adhesive layer was laminated to a foam backing. The layers were arranged so that the long axes of the adhesive stripes were oriented perpendicularly to the long axis of the foam backing (e.g., in similar manner as shown in FIG. 3), unless otherwise noted. A secondary adhesive layer (bearing a secondary release liner) was then laminated to the opposite side of the foam backing. Often the secondary adhesive layer was a continuous coating of the organic polymeric adhesive of Comparative Example PSA-O-1 (described below).

The thus-formed double-faced adhesive article could then be stored until used.

### EXAMPLES

### Single-Adhesive Comparative Examples

Comparative Example PSA-O-1 comprised a continuous coating of PSA-O-1 (organic polymeric adhesive). To do this, the coating solution was expelled from the die-slot openings in discrete streams, but the flowrate of coating solution was such, and the release liner passed by the die in such manner, that the deposited stripes laterally merged with each other to form a continuous coated layer. Comparative Example PSA-O-1, when tested in the Elevated Humidity/Static Shear Test Method, exhibited a test result (time to failure) of approximately 2500 minutes.

Comparative Example PSA-S-2 comprised a continuous coating of PSA-S-2 (silicone-based adhesive in which the silicone elastomer was a silicone polyoxamide), coated in generally similar manner as Comparative Example PSA-O-1. Comparative Example PSA-S-2, when tested in the Elevated Humidity/Static Shear Test Method, exhibited a test result (time to failure) of >30000 minutes. Although not included herein as a specific Comparative Example, it is noted that continuous coatings of PSA-S-1 (silicone-based adhesive in which the silicone elastomer was a silicone polyurea) had similarly been found to meet the >30000 minute threshold in such testing.

Stripe-Coated Working Examples

In order to save space in the Tables, it is stipulated that all Working Examples in the following Tables exhibited a result of >30000 minutes in an Elevated Humidity/Static Shear Test, excepting Comparative Examples C1, C2 and C3 as specifically discussed below. Also, in all Examples the silicone-based adhesive was PSA-S-2 (in which the silicone elastomer was a silicone polyoxamide) unless specifically indicated. To save space in the following Tables, the following abbreviations are used in the Tables:

Key

| Abbreviation | Units | Parameter |
|---|---|---|
| W-S | Mils | Width of silicone-based adhesive stripes |
| W-O | Mils | Width of organic polymeric adhesive stripes |
| W-G | Mils | Width of (empty) gap between adhesive stripes |
| T-S | Mils | Thickness of silicone-based adhesive stripes |
| T-O | Mils | Thickness of organic polymeric adhesive stripes |
| P | Mm | Pitch, in mm |
| OAF-S | % | Overall area fraction, silicone adhesive |
| OAF-O | % | Overall area fraction, organic polymeric adhesive |
| GAF | % | Gap area fraction |
| W-S (LS) | Mils | Width of silicone-based adhesive stripes (liner side) |
| W-S (OS) | Mils | Width of silicone-based adhesive stripes (opposite |
| | | side) |
| W-O (LS) | Mils | Width of organic polymeric adhesive stripes (liner |
| | | side) |
| W-O (OS) | Mils | Width of organic polymeric adhesive stripes (opp. |
| | | side) |
| AF-S (LS) | % | Area fraction, silicone adhesive (liner side) |
| AF-S (OS) | % | Area fraction, silicone adhesive (opposite side) |
| VF-S | % | Volume fraction, silicone adhesive (for selected |
| | | examples) |

The width (W) and thickness (T) of the various stripes were measured optically as described previously. The pitch (P, reported in mm) was indicative of the overall (average) center-to-center distance between adjacent stripes (and sub-stripes, if present). The stripe pitch was typically fairly uniform with the center-to-center distance between any two specific stripes closely approximating the overall average pitch. For clarity of presentation, in Table 3 the widths of the various stripes in the silicone surface-enriched sample are omitted (as are parameters relating to gaps since no gaps were present in this Example). Area fractions were calculated from the measured stripe widths as described above.

Stripes with Gaps in Between

Table 1 shows parameters for stripes arranged with gaps therebetween (i.e., stripes of the general type illustrated in FIG. 1). In Comparative Examples C1, C2, and C3, and in Working Examples 1-1, 1-2, 1-3, 1-4, 1-5, 1-7, 1-8, 1-10, 1-11, and 1-14, each stripe of silicone adhesive was followed by two sub-stripes of organic polymeric adhesive (that is, using the previously-discussed nomenclature, the generally alternating pattern was 20/(40/40)/20/(40/40) . . . ). In Working Examples 1-6, 1-9, 1-12, 1-13, and 1-15, each stripe of silicone-based adhesive was followed by a single stripe of organic polymeric adhesive (that is, using the previously-discussed nomenclature, the generally alternating pattern was 20/40/20/40 . . . ). In Comparative Example C3 and in Working Examples 1-10, 1-12, and 1-15, the silicone-based adhesive was PSA-S-1 (comprising a silicone-polyurea elastomer); in all others the silicone-based adhesive was PSA-S-2 (comprising a silicone-polyoxamide elastomer).

TABLE 1

| No. | W-S | W-O | W-G | OAF-S | OAF-O | GAF | T-S | T-O | P | VF-S |
|---|---|---|---|---|---|---|---|---|---|---|
| C1 | 36.2 | 97.7 | 23.9 | 12 | 64 | 24 | 2.0 | 3.4 | 1.7 | 7.5 |
| C2 | 30.4 | 23.0 | 42.7 | 15 | 22 | 63 | 1.4 | 2.5 | 2.0 | 9.9 |
| C3 | 40.4 | 36.2 | 28.9 | 20 | 36 | 43 | 1.4 | 3.5 | 2.1 | 10 |
| 1-1 | 47.7 | 34.6 | 30.4 | 23 | 33 | 44 | 1.7 | 2.8 | 1.7 | 16 |
| 1-2 | 44.1 | 36.9 | 20.7 | 25 | 41 | 35 | 2.3 | 2.8 | 1.6 | 22 |
| 1-3 | 53.1 | 36.0 | 27.2 | 26 | 35 | 39 | 1.7 | 3.0 | 1.8 | 18 |
| 1-4 | 59.4 | 28.1 | 31.0 | 28 | 27 | 45 | 1.9 | 2.9 | 1.7 | 22 |
| 1-5 | 53.1 | 29.3 | 24.0 | 29 | 32 | 39 | 2.6 | 2.7 | 1.5 | 28 |
| 1-6 | 38.1 | 32.2 | 29.7 | 29 | 25 | 46 | 0.7 | 1.0 | 1.7 | 24 |
| 1-7 | 56.7 | 32.3 | 22.8 | 30 | 34 | 36 | 2.6 | 2.4 | 1.7 | 31 |
| 1-8 | 52.5 | 31.0 | 16.0 | 32 | 38 | 30 | 2.2 | 1.3 | 1.4 | 42 |
| 1-9 | 43.7 | 33.6 | 23.0 | 35 | 27 | 37 | 2.4 | 1.5 | 1.7 | 43 |
| 1-10 | 63.9 | 56.6 | 2.5 | 35 | 61 | 4 | 1.2 | 2.0 | 1.6 | 39 |
| 1-11 | 58.3 | 33.1 | 10.6 | 37 | 42 | 20 | 2.2 | 1.5 | 1.4 | 45 |
| 1-12 | 111 | 85.3 | 39.4 | 40 | 31 | 29 | 4.0 | 6.0 | 3.2 | 33 |
| 1-13 | 56.0 | 34.4 | 22.4 | 41 | 25 | 33 | 1.0 | 1.5 | 1.7 | 34 |
| 1-14 | 76.0 | 32.4 | 13.3 | 42 | 36 | 22 | 2.2 | 1.4 | 1.7 | 52 |
| 1-15 | 125 | 85.3 | 23.6 | 48 | 33 | 18 | 3.4 | 5.1 | 2.8 | 40 |

In Table 1, the data is arranged in increasing order of the overall area fraction of silicone-based adhesive (OAF-S). Comparative Examples C1, C2, and C3 (at overall area fractions of silicone-based adhesive of 12, 15, and 20%) respectively exhibited times to failure of 11500 minutes, 8600 minutes, and 4800 minutes, in an Elevated Humidity/Static Shear Test. All other Examples achieved a test result of >30000 minutes.

Stripes without Gaps in Between

Table 2 shows parameters for stripes arranged without gaps therebetween and with lateral sidewalls in generally lateral contact with each other (i.e., stripes of the general arrangement of FIG. 5). These samples were all of the 20/40/20/40 generally alternating pattern. For these samples (in which no gaps were present), the overall area fraction (OAF) of each adhesive was substantially equivalent to the adhesive-only area fraction of each adhesive.

TABLE 2

| No. | W-S | W-O | OAF-S | OAF-O | T-S | T-O | P | VF-S |
|---|---|---|---|---|---|---|---|---|
| 2-1 | 66.7 | 133.5 | 33 | 67 | 0.8 | 2.7 | 2.5 | 13 |
| 2-2 | 62.5 | 111.2 | 36 | 64 | 0.7 | 1.8 | 2.3 | 18 |
| 2-3 | 108.7 | 94.1 | 54 | 46 | 0.8 | 1.1 | 2.5 | 46 |
| 2-4 | 108.0 | 66.1 | 62 | 38 | 1.2 | 2.2 | 2.3 | 47 |

Stripes with Silicone Surface-Enrichment

Table 3 shows parameters for stripes arranged without gaps therebetween and with surface-enrichment of the silicone-based adhesive being observed at the surface of the adhesive layer that was in contact with the release liner (i.e., stripes of the general arrangement of FIG. 6). This sample was of the 20/40/20/40 generally alternating pattern. In Table 3, the opposite-side and liner-side area fractions are only listed for the first, silicone-based adhesive. For this sample, the balance of the opposite-side and liner-side area fractions were occupied by the second, organic polymeric adhesive.

TABLE 3

| No. | AF-S (OS) | AF-S (LS) | T-S | T-O | P |
|---|---|---|---|---|---|
| 3-1 | 52 | 77 | 1.1 | 2.2 | 2.1 |

In these data, comparison of the liner-side surface area fraction of silicone adhesive (AF-S(LS)) to the opposite-side fraction of silicone adhesive (AF-S(OS)) reveals the surface enrichment of the liner-side surface of the adhesive layer that can be achieved if desired. That is, Working Example 3-1 had an opposite-side area fraction of silicone-based adhesive of approximately 52%, and yet the surface of the adhesive layer against the release liner was found to exhibit a silicone-based adhesive area fraction of approximately 77%. For further clarification, Table 3A presents the actual optically observed widths of the silicone-based adhesive stripes at the release liner surface (W-S(LS)) versus the optically observed widths of these stripes at the opposite surface (W-S(OS)). The widths for the organic polymeric adhesive stripes are also listed in Table 3A. (The surface area fractions of silicone-based adhesive listed in Table 3 were calculated from the width data of Table 3A.).

TABLE 3A

| No. | W-S (LS) | W-S (OS) | W-O (LS) | W-O (OS) |
|---|---|---|---|---|
| 3-1 | 133.2 | 89.5 | 40.6 | 84.3 |

The foregoing Examples have been provided for clarity of understanding only. No unnecessary limitations are to be understood therefrom. The tests and test results described in the Examples are intended solely to be illustrative, rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary structures, features, details, configurations, etc., that are disclosed herein can be modified and/or combined in numerous embodiments. (In particular, all elements that are positively recited in this specification as alternatives, may be explicitly included in the claims or excluded from the claims, in any combination as desired.) All such variations and combinations are contemplated by the inventor as being within the bounds of the conceived invention not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. An article comprising:
a first substrate that is a release liner comprising a release surface on at least a first major surface thereof;
a secondary substrate that is a conformal backing and that comprises a first major surface thereof;
a primary adhesive layer comprising a first major surface that is in contact with the first major surface of the release liner and a second major surface that is in contact with the first major surface of the conformal backing,
wherein the primary adhesive layer comprises a plurality of stripes of a first pressure-sensitive adhesive and of a second pressure-sensitive adhesive, arranged in a generally alternating pattern across at least a lateral extent of the release liner;
and wherein an average thickness of the stripes of the second pressure-sensitive adhesive is greater than an average thickness of the stripes of the first pressure-sensitive adhesive by a factor of at least 1.2 and wherein a thickness of the conformal backing is at least about four times a thickness of the primary adhesive layer.

2. The article of claim 1, wherein the first pressure-sensitive adhesive is a silicone-based adhesive that comprises a silicone elastomer, and wherein the second pressure-sensitive adhesive is an organic polymeric pressure-sensitive adhesive.

3. The article of claim 2, wherein the silicone elastomer is a silicone block copolymer elastomer selected from the group consisting of urea-based silicone block copolymers, oxamide-based silicone block copolymers, amide-based silicone block copolymers, and urethane-based silicone block copolymers, and mixtures and blends thereof.

4. The article of claim 2, wherein the organic polymeric pressure-sensitive adhesive comprises an organic elastomer selected from the group consisting of styrenic block copolymer elastomers, natural rubber elastomers, (meth)acrylate elastomers, and mixtures and blends thereof.

5. The article of claim 1 wherein at least selected stripes of the first pressure-sensitive adhesive each extend continuously from a first major surface that is in contact with the release surface of the first substrate, to a second, oppositely-facing major surface that is adhesively bonded to the first major surface of the conformal backing.

6. The article of claim 1, wherein the conformal backing is a highly extensible tape backing and wherein the tape backing and the primary adhesive layer collectively provide a length of stretch-releasable adhesive tape.

7. The article of claim 6, further comprising a secondary adhesive layer disposed on a second major side of the tape backing that is oppositely-facing from the first major side of the tape backing, wherein the tape backing and the primary and secondary adhesive layers collectively provide a double-faced stretch-releasable adhesive tape.

8. The article of claim 1, wherein at least selected pairs of laterally adjacent stripes of the first pressure-sensitive adhesive and the second pressure-sensitive adhesive each comprise a gap between the first pressure-sensitive adhesive stripe of the pair and the second pressure-sensitive adhesive stripe of the pair, which gap comprises an exposed portion of the release surface of the first substrate, which exposed portion of the release surface is not in contact with any pressure-sensitive adhesive.

9. The article of claim 8, wherein the primary adhesive layer comprises a gap area fraction of up to about 50%.

10. The article of claim 1, wherein at least selected pairs of laterally adjacent stripes of the first pressure-sensitive adhesive and the second pressure-sensitive adhesive each comprise a minor surface of a lateral edge of the first pressure-sensitive adhesive stripe of the pair that is in generally lateral contact with a minor surface of a lateral edge of the second pressure-sensitive adhesive stripe of the pair.

11. The article of claim 1, wherein at least selected pairs of laterally adjacent stripes of the first pressure-sensitive adhesive and the second pressure-sensitive adhesive are each configured so that a lateral edge portion of the first pressure-sensitive adhesive stripe of the pair comprises a first major surface that is in contact with the release surface of the first substrate and so that the lateral edge portion of the first pressure-sensitive adhesive further comprises a second, generally oppositely-facing major surface that is in contact with a major surface of a lateral edge portion of the second pressure-sensitive adhesive stripe of the pair, wherein the lateral edge portion of the first pressure-sensitive adhesive stripe inwardly underlies the lateral edge portion of the second pressure-sensitive adhesive stripe.

12. The article of claim 1, wherein the first pressure-sensitive adhesive provides a volume fraction of the primary adhesive layer that is from greater than 10%, to about 55%.

13. The article of claim 1, wherein the thickness of the conformal backing is at least about eight times the thickness of the primary adhesive layer.

14. The article of claim 1, wherein the thickness of the conformal backing is at least about twelve times the thickness of the primary adhesive layer.

15. The article of claim 1, wherein the thickness of the conformal backing is at least about sixteen times the thickness of the primary adhesive layer.

16. The article of claim 1, wherein the average thickness of the stripes of the second pressure-sensitive adhesive is greater than an average thickness of the stripes of the first pressure-sensitive adhesive by a factor of at least 1.6.

17. The article of claim 1, wherein the average thickness of the stripes of the second pressure-sensitive adhesive is greater than an average thickness of the stripes of the first pressure-sensitive adhesive by a factor of at least 2.0.

18. The article of claim 1, wherein the average thickness of the stripes of the second pressure-sensitive adhesive is greater than an average thickness of the stripes of the first pressure-sensitive adhesive by a factor of at least 2.5.

19. The article of claim 1, wherein the average thickness of the stripes of the second pressure-sensitive adhesive is greater than an average thickness of the stripes of the first pressure-sensitive adhesive by a factor of at least 3.0.

20. The article of claim 1, wherein the average thickness of the stripes of the second pressure-sensitive adhesive is greater than an average thickness of the stripes of the first pressure-sensitive adhesive by a factor of about 3.5.

21. An article comprising:
a first substrate that comprises a first major surface thereof;
a secondary substrate that comprises a first major surface thereof;
a primary adhesive layer comprising a first major surface that is in contact with the first major surface of the first substrate and a second major surface that is in contact with the first major surface of the secondary substrate,
wherein the primary adhesive layer comprises a plurality of stripes of a first, silicone-based pressure-sensitive adhesive and of a second, organic polymeric pressure-sensitive adhesive, arranged in a generally alternating pattern across at least a lateral extent of the release liner;
wherein the stripes of the first, silicone-based pressure-sensitive adhesive provide a volume fraction of the primary adhesive layer of from greater than about 10%, to about 55%,
and wherein the primary adhesive layer exhibits an Elevated Humidity/Static Shear Test result of >30000 minutes.

22. The article of claim 21, wherein the stripes of the first, silicone-based pressure-sensitive adhesive provide a volume fraction of the primary adhesive layer of from about 13% to about 52%.

23. The article of claim 21, wherein the stripes of the first, silicone-based pressure-sensitive adhesive provide a volume fraction of the primary adhesive layer of from about 15% to about 50%.
